(19) United States
(12) Patent Application Publication
(10) Pub. No.: US 2026/0320601 A1
(43) Pub. Date: Oct. 15, 2026

(54) SYSTEMS AND METHODS FOR A CUSTOMER EXPERIENCE AND TECHNOLOGY SOLUTION

(71) Applicant: JPMORGAN CHASE BANK, N.A., New York, NY (US)

(72) Inventors: Michael PARKER, Golden, CO (US); Temsiri JUAREZ, Plano, TX (US); Varun PANDEY, Budd Lake, NJ (US); Christine SIROIS, Brooklyn, NY (US); Hyeji JUN, McKinney, TX (US); Angelica VLATTAS, Manhattan, NY (US); Olya S JOHNSON, New York, NY (US); Varun AWASTHI, Jersey City, NJ (US); Praveen NAREDDY, Carrollton, TX (US); Santoshkumar NAYAK, Edison, NJ (US); Ljubica CHATMAN, New York, NY (US); Dhruvkumar PATEL, Secaucus, NJ (US); Hanamantgouda NAGANUR, West Windsor, NJ (US)

(21) Appl. No.: 19/647,511

(22) Filed: Apr. 14, 2026

Related U.S. Application Data
(60) Provisional application No. 63/788,633, filed on Apr. 14, 2025.

(51) Int. Cl. G06Q 20/40

(52) U.S. Cl. CPC G06Q 20/401

(57) ABSTRACT

In some embodiments, the techniques described herein relate to a method including: receiving, by an application executed by one or more processors, a payment request by an application associated with a first account; creating, by the application, a payment request message based on the payment request; validating, by a merchant financial institution, the payment request message; submitting the payment request message to a receiver financial institution; validating, at the receiver financial institution, the payment request message; creating a token out of the requested parameter comprising the payment request message; receiving the token at the merchant financial institution and the first account application; selecting, by a first account application, the link; decoding, by a receiver financial institution upon selection of the link the token; receiving one or more login details from the user electronic device; and blocking a transaction if login credentials are not verified.

### RELATED APPLICATIONS

This application claims priority to, and the benefit of, U.S. Provisional Patent Application Ser. No. 63/788,633, filed Apr. 14, 2025, the disclosure of which is hereby incorporated, by reference in its entirety.

### BACKGROUND

### 1. Field of the Invention

Embodiments generally relate to systems and methods for payment transfer.

### 2. Description of the Related Art

In many existing money transfer environments, a customer seeking to move funds between linked accounts, including accounts maintained at different financial institutions, may be required to initiate a transfer through a first account interface and wait for review and processing by a separate recipient system. Conventional approaches frequently rely on automated clearing house processing or other delayed settlement mechanisms, such that completion of the transfer may take multiple business days. These approaches may involve repeated review of transfer details by separate systems and, in some instances, by account managers or other personnel, which may increase latency, consume computing and operational resources, and introduce opportunities for manual error.

Existing transfer workflows may also create friction in the customer experience. For example, after a customer initiates a transfer from a partner or merchant application, the customer may be required to separately access a financial institution platform to complete approval of the transaction. In many implementations, there is no efficient mechanism for securely transitioning the customer from a transfer-request interface associated with one account to an approval interface associated with another account while preserving transfer context and reducing repeated data entry. As a result, conventional systems may require the customer to manually navigate between applications, re-enter credentials, and re-confirm transaction information, thereby increasing abandonment risk and processing inefficiency.

Recent payment rail infrastructures, including Request for Payment (RfP) and real-time payment (RTP) infrastructures, enable faster movement of funds. However, the availability of such payment rails does not, by itself, provide a complete customer-facing and back-end workflow for secure approval and settlement of account-to-account transfers. In particular, existing implementations may lack standardized techniques for presenting an RfP transfer option to a customer, securely relaying transfer-related information between a merchant financial institution and a receiver financial institution, and guiding the customer to an approval process associated with the receiver financial institution.

Further, when a transfer is to be completed in real time, institutions may require improved mechanisms for validating customer credentials, correlating a payment request with a particular customer and transfer session, and reviewing payment details and customer information before settlement. Without such mechanisms, systems may remain susceptible to entry mistakes, mismatched customer information, unauthorized transactions, or other security concerns. Accordingly, there is a need for improved systems and methods that support efficient, secure, and timely payment transfers between accounts, including transfers that leverage RfP and RTP infrastructures while reducing manual intervention and improving transaction verification.

### SUMMARY

Exemplary embodiments provide systems and methods for a customer experience and technology solution for payment transfer. According to one embodiment, a method may include receiving, by an application executed by one or more processors, a payment request by an application associated with a first account; creating, by the application, a payment request message based on the payment request; validating, by a merchant financial institution, the payment request message; submitting the payment request message to a receiver financial institution; validating, at the receiver financial institution, the payment request message; creating a tokenized uniform resource locator (“URL”) out of the requested parameter comprising the payment request message; receiving the tokenized URL at the merchant financial institution and the first account application; selecting, by a first account application, the link; decoding, by a receiver financial institution upon selection of the link the tokenized URL; receiving one or more login details from the user electronic device; and blocking a transaction if login credentials are not verified. In some embodiments, if the payment request message is validated, if the tokenized URL is decoded, and/or if the one or more login details from the user electronic device are checked successfully, then the payment transfer associated with the payment request may be conducted.

Systems and methods disclosed herein may be directed to techniques for processing a payment request using a tokenized URL and verification by a receiver financial institution. In particular, a method may comprise an application receiving a payment request associated with a first account, creating a payment request message, and/or providing the payment request message for merchant validation and submission to a receiver financial institution. The receiver financial institution may create a tokenized URL from a requested parameter including the payment request message, and the merchant may receive and use the tokenized URL to generate a link for the application associated with the first account. A response to the link, including customer credentials, may be received by the receiver financial institution, which decodes the tokenized URL. The receiver financial institution may receive a request for payment form and customer details, may compare the form and customer details against a customer information database, and may block the transaction when verification is not achieved.

Systems and methods disclosed herein may further specify that one or more of creating the payment request message, creating the tokenized URL, and decoding the tokenized URL may each be performed by calling an application programming interface service. Systems and methods disclosed herein may further specify that the tokenized URL may be encoded with a unique payment identifier, a customer identifier, and/or a link to the request for payment form.

Embodiments consistent with the present disclosure include a system including one or more processors and one or more storage devices storing instructions that when executed by one or more processors, cause the processor to perform one or more steps of the methods disclosed herein. Embodiments consistent with the present disclosure include a computer processing system, computer, or server, including: a memory configured to store instructions such as a non-transitory computer-readable storage medium; and a hardware processor operatively coupled to the memory for executing the instructions to perform one or more steps of the methods disclosed herein.

### BRIEF DESCRIPTION OF THE DRAWINGS

In order to facilitate a fuller understanding of the present invention, reference is now made to the attached drawings. The drawings should not be construed as limiting the present invention but are intended only to illustrate different aspects and embodiments.

FIG. 1 is a block diagram of a system for a customer experience and technology solution for payment transfer, in accordance with embodiments.

FIG. 2 is a method for a customer experience and technology solution for payment transfer, in accordance with embodiments.

FIG. 3 is a block diagram of a computing device for implementing certain embodiments of the present disclosure.

### DETAILED DESCRIPTION

Embodiments generally relate to systems and methods for a customer experience and technology solution for payment transfer.

In some embodiments, the disclosed systems and methods provide a customer experience and technology solution for payment transfer between accounts associated with a common customer and maintained by different financial institutions, service providers, or account platforms. The disclosed systems and methods may be implemented to support request for payment processing, real-time payment processing, or both, while maintaining a coordinated user workflow between a first account application and a second account application. The disclosed systems and methods may reduce transfer delay relative to transfer processes that rely on conventional automated clearing house routing, may reduce repeated manual review by separate account managers, may reduce data-entry error by preserving payment context across multiple systems, and/or may improve security by requiring credential validation and customer-detail verification before settlement of a requested transfer.

Conventional systems may require a user to open a first account to begin a transfer to a second account, after which a recipient system managing the second account separately receives and analyzes details of the transfer and routes the payment through an automated clearing house. Such processing may take several business days. For example, a recipient financial institution may analyze, for a given transaction between a customer account and a brokerage account, the details of the payment and take several business days to complete the transfer. These systems are further susceptible to entry mistakes introduced by the user or by the transfer system itself. By comparison, the disclosed systems and methods may provide a seamless and secure transfer between accounts that is quick and efficient by coordinating transfer initiation at a first account platform, secure tokenized linking between platforms, credential validation at a receiver financial institution, automated risk review, and/or settlement over a real-time payment rail.

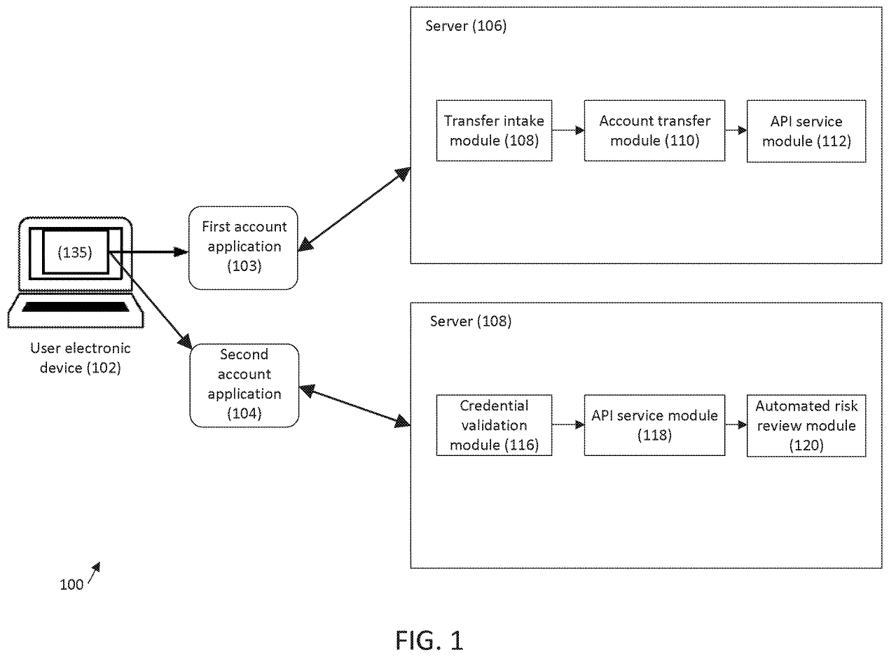

FIG. 1 illustrates a system 100 for a customer experience and technology solution for payment transfer. The system 100 may include a user electronic device 102. The user electronic device 102 may include, for example, a mobile phone, tablet computer, laptop computer, desktop computer, wearable device, or another computing device configured to communicate over a wired or wireless interface with one or more networks, including the Internet, and/or with remote computing systems. The user electronic device 102 executes an account management application available through a user interface 135. The user interface 135 may include a touchscreen interface, graphical user interface, keyboard interface, voice interface, and/or another interface through which a user may review account information, enter credentials, select transfer options, approve a payment request, decline a payment request, and/or receive status or confirmation information.

In some embodiments, the user electronic device 102 executes a first account application 103 and a second account application 104. The first account application 103 may be associated with a first account, such as a source account, brokerage account, merchant-associated account, partner-platform account, or another account from which a payment request is initiated. The second account application 104 may be associated with a second account, such as a funding account or deposit account maintained at a receiver financial institution from which funds are to be transferred responsive to the payment request. In some embodiments, the first account application 103 communicates with a first server 106 and the second account application 104 communicates with a second server 108. In some embodiments, the first account application 103 and the second account application 104 are separate applications. In some embodiments, the first account application 103 and the second account application 104 may each be instances, modules, or interfaces of a broader account management platform. In some embodiments, the user electronic device 102 may automatically foreground the second account application 104 when a tokenized URL is selected. In some embodiments, the selection may be manual through the user interface 135.

The first server 106 may comprise a networked computer system including one or more processors executing one or more software modules and one or more memories storing data accessible by the software modules and instructions executable by the processors. The first server 106 may be associated with a merchant, partner institution, brokerage platform, or another system through which the user initiates a payment request. In some embodiments, the first server 106 includes a transfer intake module 108, an account transfer module 110, and/or an application programming interface (“API”) service module 112. The transfer intake module 108 may receive transfer selections made through the first account application 103 and may generate a transfer message or payment request message based on the selected money transfer. The payment request message may include payment details such as an amount, account details, payee details, a customer identifier, a transaction reference, a timing parameter, or other transfer-related data. The account transfer module 110 may receive the payment request message from the transfer intake module 108 and may determine whether the user and the requested transfer are eligible for a real-time payment process. For example, the account transfer module 110 may determine whether the user is transferring between known accounts, whether the known accounts are associated with a first financial institution and a second financial institution that support request for payment or real-time payment processing, whether transaction limits are satisfied, whether the transfer falls within an allowed time window, or whether account status and other rules support a real-time transfer flow. The API service module 112 may support communication between the first server 106 and the second server 108, including formatting messages, sending payment details over a secure communication line, receiving a tokenized URL from the second server 108, and/or causing presentation of a transfer option or approval link through the first account application 103.

The second server 108 may comprise a networked computer system including one or more processors executing one or more software modules and one or more memories storing data accessible by the software modules and instructions executable by the processors. The second server 108 may be associated with a receiver financial institution, funding institution, or other institution that receives the payment request message and controls release of funds responsive to customer approval and verification. In some embodiments, the second server 108 includes a credential validation module 116, an API service module 118, and/or an automated risk review module 120. The credential validation module 116 may receive credentials supplied through the user electronic device 102 and determine whether the user and, in some embodiments, the user electronic device 102 are authorized to access the second account application 104 and approve the requested transfer. The API service module 118 may generate a tokenized URL responsive to the payment request message and may later decode or decipher the tokenized URL after the link is selected. The automated risk review module 120 may compare customer details, device details, transfer details, payment-form details, or combinations thereof to records stored in one or more customer information databases and may determine whether the requested transaction is to proceed, be blocked, or be subjected to additional verification.

One or more databases associated with the first server 106 and the second server 108 may be accessed by the respective modules and may include instructions for the modules, account records, customer identifiers, device profiles, credential information, transfer history, transaction rules, limits, approval states, audit records, or other information used to perform the disclosed operations. In some embodiments, account details accessible by the application executed on the user electronic device 102 may be stored in a temporary database, a permanent database, a memory, and/or a group of memories associated with the first server 106, the second server 108, or a broader computer network. In some embodiments, the databases may store known-account associations that enable the account transfer module 110 to determine whether a requested transfer is between accounts associated with the same user.

In operation, a user may log in through the user interface 135 to the first account application 103 using secure user information that is accepted by the first server 106. The user may select a money transfer through the first account application 103. In response, the transfer intake module 108 may generate a transfer message based on the selected money transfer and may pass the transfer message to the account transfer module 110. The account transfer module 110 may determine whether the user is eligible for a real-time payment transfer and whether the transfer is between known accounts associated with the financial institution operating or managing the first account and the second account associated with the first account application 103 and the second account application 104, respectively. If approved, the account transfer module 110 may send payment details, including an amount, account details such as a name and account number, and/or payee details such as a recipient, to the API service module 112.

The API service module 112 may be called to present a request for payment or real-time payment option to the user through the user interface 135. In some embodiments, the transfer option may be presented as an express transfer option, a real-time transfer option, or another user-selectable transfer mode. In some embodiments, the API service module 112 may initiate a request to begin the transfer with or without separate user approval of the request for payment request at that stage. The API service module 112 may communicate with the second server 108 via a secure communication line, such as a real-time payment rail, and may provide the payment details for receiver-side processing. In some embodiments, the communication may employ one or more network-level message protocols to relay data between financial institutions. Use of the secure communication line and associated message protocols may reduce latency, reduce dependency on delayed batch-settlement systems, and/or improve interoperability between account platforms participating in the transfer flow.

After receipt of the payment details, the second server 108 may validate the payment request message and may call the API service module 118 to generate a tokenized URL for the user. The tokenized URL may be distinct and secure. In some embodiments, the tokenized URL may be encoded with one or more of a payment identifier, a dedicated payment identifier, a request for payment identifier, a customer identifier, an expiration date or expiration time, and/or a link to a payment approval process or request for payment approval process by way of a login front door associated with the second account application 104. In some embodiments, the tokenized URL may be encrypted. The tokenized URL may be sent from the second server 108 to the first server 106, and/or the first server 106 may provide the tokenized URL through the first account application 103 to the user electronic device 102. Because the tokenized URL may carry transfer context in encoded form, the user may be transitioned from the first account application 103 to the second account application 104 without manually re-entering transfer data, thereby reducing user friction and reducing opportunities for data mismatch.

The user electronic device 102 may automatically or manually, such as through the user interface 135, select the link associated with the tokenized URL to log in to or otherwise access the second account application 104. The second server 108, by way of the credential validation module 116, may validate the user and, in some embodiments, the user electronic device 102. The credential validation module 116 may receive one or more login credentials and compare the received credentials to stored credential information. If the credentials are approved, the credential validation module 116 may call the API service module 118 to decipher the encoded tokenized URL. In some embodiments, if the credentials are not verified, the second server 108 may send an error screen, terminate the transaction, or both. Requiring validation at the second server 108 may improve security by ensuring that the transfer is approved only after authentication within the receiver financial institution environment.

After the tokenized URL is decoded, the second server 108 may present the request for payment to the user through the second account application 104. In some embodiments, the user may be presented with an option to accept or decline the transfer. In some embodiments, the user may be presented with an option to submit approval of the transfer after reviewing the displayed payment details. The displayed payment details may be based on the payment request and may include the transfer amount, the receiving account, the funding account, a timing parameter, a note field, expiration information, or other transfer information. In some embodiments, the user electronic device 102 may complete and submit a payment form containing the payment details to the second server 108.

The automated risk review module 120 may determine whether customer details and, in some embodiments, details of the user electronic device 102 match information associated with the user in a customer information database. The comparison may include comparing the request for payment form and one or more customer details against customer records, account records, device profiles, prior transfer history, or other stored information. In some embodiments, the automated risk review module 120 may perform an automated risk review before allowing settlement. In some embodiments, further out-of-channel verification may be implemented, such as a phone call, text message, and/or another secondary communication, before blocking or approving the transaction. If risk verification is successful, the second server 108 may settle the transaction by enacting the money transfer, including sending the requested money via the real-time payment rail to the destination platform associated with the first server 106. If risk verification is not successful, the second server 108 may reject the money transfer or block the transaction associated with the payment request. Use of automated risk review in combination with optional out-of-channel verification may improve fraud resistance while maintaining a streamlined transfer workflow for authorized transactions.

The disclosed architecture may provide several technical benefits. By transferring payment data over a secure communication line and using a tokenized URL rather than exposing transfer information in plain form, the system may improve confidentiality and integrity of transfer context during movement between platforms. By encoding identifiers and approval-process information in the tokenized URL, the system may maintain linkage between the initiated request and the subsequent approval event, thereby reducing state-loss issues that may otherwise occur when moving from one application environment to another. By validating credentials at the receiver financial institution and comparing payment-form details and customer details against a customer information database, the system may reduce unauthorized or mismatched transfers. By enabling settlement over a real-time payment rail, the system may reduce transfer-completion time relative to automated clearing house processing. By reducing dependence on manual review by separate account managers, the system may reduce operational burden, reduce processing delay, and/or reduce errors introduced during repeated re-entry or review of payment details.

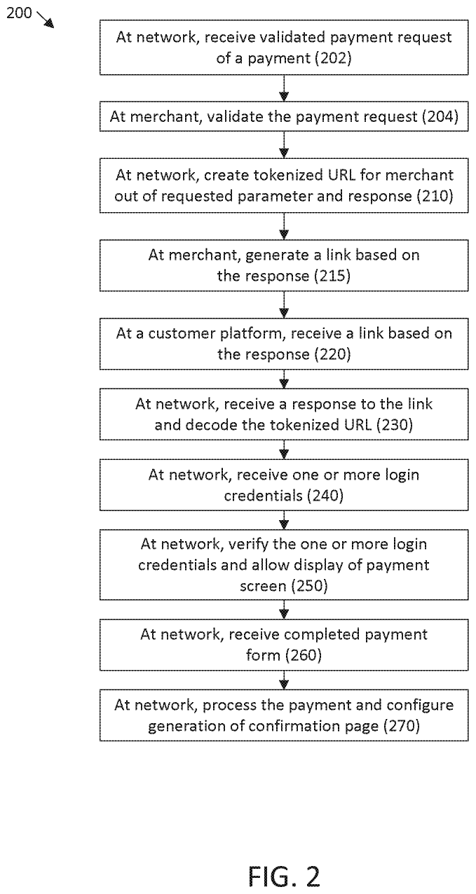

FIG. 2 illustrates a method 200 for a customer experience and technology solution for payment transfer. The method 200 may be stored as a list of instructions in a memory that, when executed by one or more processors, cause the one or more processors to perform the method. In some embodiments, the method 200 may be carried out by one or more components of the system 100 of FIG. 1. At 202, a network system receives a validated payment request of a payment. In some embodiments, the validated payment request may correspond to a payment request message created based on a payment request received by the first account application 103 and validated by a merchant or partner system prior to network-side handling. At 204, a merchant validates the payment request. In some embodiments, the validation at 204 may include verifying formatting, checking transaction eligibility, checking account associations, and/or confirming that the request is suitable for request for payment or real-time payment processing.

At 210, the network system creates a tokenized URL for the merchant out of a requested parameter and a response. In some embodiments, the requested parameter comprises the payment request message or information derived therefrom. In some embodiments, the response may include routing information, approval-process information, a token, or another parameter returned by the receiver-side system. The tokenized URL created at 210 may include encoded payment and customer context so that the merchant does not need to reconstruct the approval request independently. At 215, the merchant generates a link based on the response. In some embodiments, the merchant may embed the tokenized URL in instructional copy, a button, a selectable control, or another interface element presented through the first account application 103. At 220, a customer platform receives a link based on the response. The customer platform may correspond to the user electronic device 102, which may receive and render the link in the first account application 103.

At 230, the network system receives a response to the link and decodes the tokenized URL. In some embodiments, the response to the link is generated when the user selects the link and attempts to transition to the approval flow associated with the second account application 104. Decoding the tokenized URL may recover the encoded transfer context, thereby enabling the network system to identify the corresponding payment request and associated customer. At 240, the network system receives one or more login credentials. At 250, the network system verifies the one or more login credentials and allows display of a payment screen. In some embodiments, successful verification at 250 causes the second account application 104 to display payment details and one or more approval controls, while unsuccessful verification may cause display of an error screen and termination of the transaction. At 260, the network system receives a completed payment form. In some embodiments, the completed payment form includes transfer details confirmed by the user and optionally additional customer details used in risk review. At 270, the network system processes the payment and configures generation of a confirmation page. In some embodiments, processing the payment at 270 includes comparing the payment form and customer details against a customer information database, performing automated risk review, settling the transaction over a real-time payment rail if the comparison is verified, or blocking the transaction if verification is not achieved. In some embodiments, the confirmation page indicates successful payment, while in other embodiments the generated page may indicate decline, expiration, or another transaction outcome.

The sequence shown in FIG. 2 provides further technical benefits. Separating merchant-side validation, network-side tokenized URL creation, credential verification, payment-form reception, and/or payment processing into discrete stages may improve traceability, enable modular service implementation, and/or allow security controls to be applied at multiple points in the workflow. Creating the tokenized URL at the network side and decoding the tokenized URL after receipt of the response to the link may reduce exposure of sensitive transaction state while preserving continuity between initiation and approval. Verifying credentials before display of the payment screen may restrict access to the approval interface. Processing the payment only after receipt of the completed payment form and verification of customer information may reduce erroneous or unauthorized settlement. Configuring generation of a confirmation page after processing may provide immediate feedback to the user and may improve usability for real-time transfer workflows.

Although FIG. 1 and FIG. 2 illustrate particular arrangements of components and operations, the disclosed systems and methods are not limited to the illustrated arrangement. In some embodiments, one or more modules may be combined, divided, distributed across additional computing systems, or implemented as software, hardware, firmware, or combinations thereof. In some embodiments, operations described with respect to one module may be performed by another module or by one or more shared services. In some embodiments, one or more validation, approval, display, communication, encryption, tokenization, or risk-review operations may be performed in a different order while still preserving the secure transition between the first account application 103 and the second account application 104 and the receiver-side verification prior to settlement. In some embodiments, the disclosed systems and methods may be used for me-to-me transfers, transfers between linked accounts, transfers between accounts maintained by trusted partners, or other payment-transfer scenarios in which a payment request is initiated in one application environment and approved in another application environment.

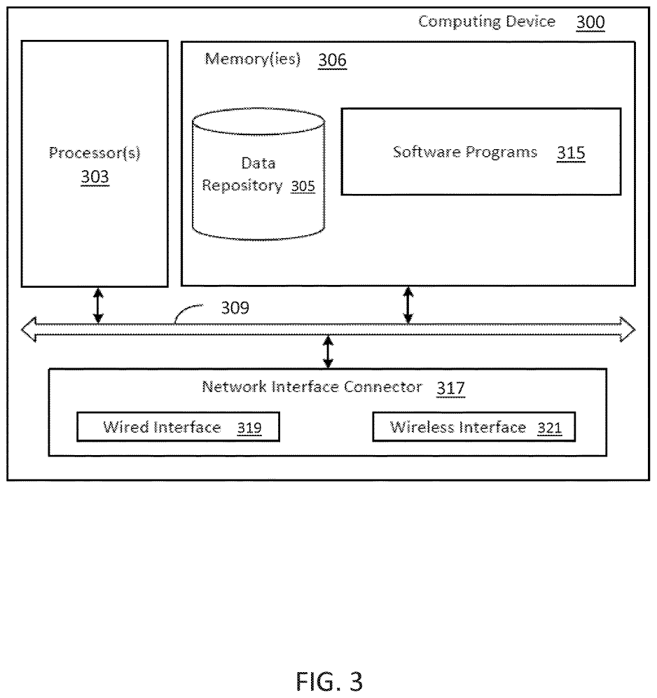

FIG. 3 is a block diagram of a computing device for implementing certain embodiments of the present disclosure. FIG. 3 depicts exemplary computing device 300. Computing device 300 may represent hardware that executes the logic that drives the various system components described herein. For example, system components such as a user device, an interface, an event streaming platform, a matching algorithm, and various database/data store engines and servers, and other computer applications and logic may include, and/or execute on, components and configurations like, or similar to, computing device 300.

Computing device 300 includes a processor 303 coupled to a memory 306. Memory 306 may include volatile memory and/or persistent memory. The processor 303 executes computer-executable program code stored in memory 306, such as software programs 315. Software programs 315 may include one or more of the logical steps disclosed herein as a programmatic instruction, which may be executed by processor 303. Memory 306 may also include data repository 305, which may be nonvolatile memory for data persistence. The processor 303 and the memory 306 may be coupled by a bus 309. In some examples, the bus 309 may also be coupled to one or more network interface connectors 317, such as wired network interface 319, and/or wireless network interface 321. Computing device 300 may also have user interface components, such as a screen for displaying graphical user interfaces and receiving input from the user, a mouse, a keyboard and/or other input/output components (not shown).

The various processing steps, logical steps, and/or data flows depicted in the figures and described in greater detail herein may be accomplished using some or all of the system components also described herein. In some implementations, the described logical steps may be performed in different sequences and various steps may be omitted. Additional steps may be performed along with some, or all of the steps shown in the depicted logical flow diagrams. Some steps may be performed simultaneously. Accordingly, the logical flows illustrated in the figures and described in greater detail herein are meant to be exemplary and, as such, should not be viewed as limiting. These logical flows may be implemented in the form of executable instructions stored on a machine-readable storage medium and executed by a processor and/or in the form of statically or dynamically programmed electronic circuitry.

The system of the invention or portions of the system of the invention may be in the form of a “processing machine” a “computing device,” an “electronic device,” a “mobile device,” etc. These may be a computer, a computer server, a host machine, etc. As used herein, the term “processing machine,” “computing device, “electronic device,” or the like is to be understood to include at least one processor that uses at least one memory. The at least one memory stores a set of instructions. The instructions may be either permanently or temporarily stored in the memory or memories of the processing machine. The processor executes the instructions that are stored in the memory or memories in order to process data. The set of instructions may include various instructions that perform a particular step, steps, task, or tasks, such as those steps/tasks described above. Such a set of instructions for performing a particular task may be characterized herein as an application, computer application, program, software program, or simply software. In one aspect, the processing machine may be or include a specialized processor.

As noted above, the processing machine executes the instructions that are stored in the memory or memories to process data. This processing of data may be in response to commands by a user or users of the processing machine, in response to previous processing, in response to a request by another processing machine and/or any other input, for example. The processing machine used to implement the invention may utilize a suitable operating system, and instructions may come directly or indirectly from the operating system.

The processing machine used to implement the invention may be a general-purpose computer. However, the processing machine described above may also utilize any of a wide variety of other technologies including a special purpose computer, a computer system including, for example, a microcomputer, mini-computer or mainframe, a programmed microprocessor, a micro-controller, a peripheral integrated circuit element, a CSIC (Customer Specific Integrated Circuit) or ASIC (Application Specific Integrated Circuit) or other integrated circuit, a logic circuit, a digital signal processor, a programmable logic device such as a FPGA, PLD, PLA or PAL, or any other device or arrangement of devices that is capable of implementing the steps of the processes of the invention.

It is appreciated that in order to practice the method of the invention as described above, it is not necessary that the processors and/or the memories of the processing machine be physically located in the same geographical place. That is, each of the processors and the memories used by the processing machine may be located in geographically distinct locations and connected so as to communicate in any suitable manner. Additionally, it is appreciated that each of the processor and/or the memory may be composed of different physical pieces of equipment. Accordingly, it is not necessary that the processor be one single piece of equipment in one location and that the memory be another single piece of equipment in another location. That is, it is contemplated that the processor may be two pieces of equipment in two different physical locations. The two distinct pieces of equipment may be connected in any suitable manner. Additionally, the memory may include two or more portions of memory in two or more physical locations.

To explain further, processing, as described above, is performed by various components and various memories. However, it is appreciated that the processing performed by two distinct components as described above may, in accordance with a further aspect of the invention, be performed by a single component. Further, the processing performed by one distinct component as described above may be performed by two distinct components. In a similar manner, the memory storage performed by two distinct memory portions as described above may, in accordance with a further aspect of the invention, be performed by a single memory portion. Further, the memory storage performed by one distinct memory portion as described above may be performed by two memory portions.

Further, various technologies may be used to provide communication between the various processors and/or memories, as well as to allow the processors and/or the memories of the invention to communicate with any other entity, i.e., so as to obtain further instructions or to access and use remote memory stores, for example. Such technologies used to provide such communication might include a network, the Internet, Intranet, Extranet, LAN, an Ethernet, wireless communication via cell tower or satellite, or any client server system that provides communication, for example. Such communications technologies may use any suitable protocol such as TCP/IP, UDP, or OSI, for example.

As described above, a set of instructions may be used in the processing of the invention. The set of instructions may be in the form of a program or software. The software may be in the form of system software or application software, for example. The software might also be in the form of a collection of separate programs, a program module within a larger program, or a portion of a program module, for example. The software used might also include modular programming in the form of object-oriented programming. The software tells the processing machine what to do with the data being processed.

Further, it is appreciated that the instructions or set of instructions used in the implementation and operation of the invention may be in a suitable form such that the processing machine may read the instructions. For example, the instructions that form a program may be in the form of a suitable programming language, which is converted to machine language or object code to allow the processor or processors to read the instructions. That is, written lines of programming code or source code, in a particular programming language, are converted to machine language using a compiler, assembler or interpreter. The machine language is binary coded machine instructions that are specific to a particular type of processing machine, i.e., to a particular type of computer, for example. The computer understands the machine language.

Any suitable programming language may be used in accordance with the various embodiments of the invention. Illustratively, the programming language used may include assembly language, Ada, APL, Basic, C, C++, COBOL, dBase, Forth, Fortran, Java, Modula-2, Pascal, Prolog, REXX, Visual Basic, and/or JavaScript, for example. Further, it is not necessary that a single type of instruction or single programming language be utilized in conjunction with the operation of the system and method of the invention. Rather, any number of different programming languages may be utilized as is necessary and/or desirable.

Also, the instructions and/or data used in the practice of the invention may utilize any compression or encryption technique or algorithm, as may be desired. An encryption module might be used to encrypt data. Further, files or other data may be decrypted using a suitable decryption module, for example.

As described above, the invention may illustratively be embodied in the form of a processing machine, including a computer or computer system, for example, that includes at least one memory. It is to be appreciated that the set of instructions, i.e., the software for example, that enables the computer operating system to perform the operations described above may be contained on any of a wide variety of media or medium, as desired. Further, the data that is processed by the set of instructions might also be contained on any of a wide variety of media or medium. That is, the particular medium, i.e., the memory in the processing machine, utilized to hold the set of instructions and/or the data used in the invention may take on any of a variety of physical forms or transmissions, for example. Illustratively, the medium may be in the form of a compact disk, a DVD, an integrated circuit, a hard disk, a floppy disk, an optical disk, a magnetic tape, a RAM, a ROM, a PROM, an EPROM, a wire, a cable, a fiber, a communications channel, a satellite transmission, a memory card, a SIM card, or other remote transmission, as well as any other medium or source of data that may be read by a processor.

Further, the memory or memories used in the processing machine that implements the invention may be in any of a wide variety of forms to allow the memory to hold instructions, data, or other information, as is desired. Thus, the memory might be in the form of a database to hold data. The database might use any desired arrangement of files such as a flat file arrangement or a relational database arrangement, for example.

In the system and method of the invention, a variety of “user interfaces” may be utilized to allow a user to interface with the processing machine or machines that are used to implement the invention. As used herein, a user interface includes any hardware, software, or combination of hardware and software used by the processing machine that allows a user to interact with the processing machine. A user interface may be in the form of a dialogue screen for example. A user interface may also include any of a mouse, touch screen, keyboard, keypad, voice reader, voice recognizer, dialogue screen, menu box, list, checkbox, toggle switch, a pushbutton or any other device that allows a user to receive information regarding the operation of the processing machine as it processes a set of instructions and/or provides the processing machine with information. Accordingly, the user interface is any device that provides communication between a user and a processing machine. The information provided by the user to the processing machine through the user interface may be in the form of a command, a selection of data, or some other input, for example.

As discussed above, a user interface is utilized by the processing machine that performs a set of instructions such that the processing machine processes data for a user. The user interface is typically used by the processing machine for interacting with a user either to convey information or receive information from the user. However, it should be appreciated that in accordance with some embodiments of the system and method of the invention, it is not necessary that a human user actually interact with a user interface used by the processing machine of the invention. Rather, it is also contemplated that the user interface of the invention might interact, i.e., convey and receive information, with another processing machine, rather than a human user. Accordingly, the other processing machine might be characterized as a user. Further, it is contemplated that a user interface utilized in the system and method of the invention may interact partially with another processing machine or processing machines, while also interacting partially with a human user.

It will be readily understood by those persons skilled in the art that the present invention is susceptible to broad utility and application. Many embodiments and adaptations of the present invention other than those herein described, as well as many variations, modifications, and equivalent arrangements, will be apparent from or reasonably suggested by the present invention and foregoing description thereof, without departing from the substance or scope of the invention.

Accordingly, while the present invention has been described here in detail in relation to its exemplary embodiments, it is to be understood that this disclosure is only illustrative and exemplary of the present invention and is made to provide an enabling disclosure of the invention. Accordingly, the foregoing disclosure is not intended to be construed or to limit the present invention or otherwise to exclude any other such embodiments, adaptations, variations, modifications, or equivalent arrangements.

1. A method comprising:
receiving, by an application executed by one or more processors, a payment request by an application associated with a first account;
creating, by the application, a payment request message based on the payment request;
validating, by a merchant, the payment request message;
submitting, by the merchant, the payment request message to a receiver financial institution;
creating, by the receiver financial institution, a tokenized uniform resource locator (“URL”) out of the requested parameter comprising the payment request message;
receiving, at the merchant, the tokenized URL;
generating, by the merchant, a link for the application associated with the first account, the link comprising an approval for the payment request;
receiving, by the receiver financial institution, a response to the link comprising one or more customer credentials;
decoding, by the receiver financial institution, the tokenized URL;
receiving, by the receiver financial institution, a request for payment form and one or more customer details;
comparing, by the receiver financial institution, the request for payment form and the one or more customer details against a customer information database; and
blocking a transaction associated with the payment request if the comparison of the request for payment form and one or more customer details is not verified.

2. The method of claim 1, wherein creating the payment request message comprises calling an application programming interface (“API”) service.

3. The method of claim 1, wherein creating the tokenized URL out of the requested parameter comprises calling an API service.

4. The method of claim 1, wherein decoding the tokenized URL comprises calling an API service.

5. The method of claim 1, wherein the tokenized URL is encoded with a unique payment identifier.

6. The method of claim 1, wherein the tokenized URL is encoded with a customer identifier.

7. The method of claim 1, wherein the tokenized URL is encoded with the link to the request for payment form.

8. The method of claim 1, further comprising:
determining, by the application, eligibility of the first account for a real-time payment transfer prior to submitting the payment request message to the receiver financial institution.

9. The method of claim 1, wherein submitting the payment request message to the receiver financial institution comprises:
transmitting the payment request message over a secure communication line comprising a real-time payment rail.

10. The method of claim 1, further comprising:
validating, by the receiver financial institution, the payment request message prior to creating the tokenized URL.

11. The method of claim 1, further comprising:
presenting, by the application associated with the first account, a real-time payment option to a user via a user interface prior to generating the link.

12. The method of claim 1, wherein receiving, by the receiver financial institution, the response to the link comprises:
receiving login credentials for a second account management application associated with the receiver financial institution.

13. The method of claim 1, further comprising:
displaying, by the receiver financial institution via a second account management application, payment details associated with the payment request after decoding the tokenized URL.

14. The method of claim 1, further comprising:
terminating, by the receiver financial institution, the transaction and providing an error screen when the one or more customer credentials are not verified.

15. The method of claim 1, wherein comparing the request for payment form and the one or more customer details against the customer information database comprises:
performing an automated risk review.

16. The method of claim 1, further comprising:
initiating an out-of-channel verification prior to blocking the transaction.

17. The method of claim 1, wherein the tokenized URL is encrypted.

18. The method of claim 1, wherein the tokenized URL is encoded with an expiration date.

19. A system comprising:
a merchant computing system comprising one or more merchant processors and one or more merchant memories storing merchant instructions that, when executed by the one or more merchant processors, cause the merchant computing system to perform operations comprising:
receiving a payment request by an application associated with a first account;
creating a payment request message based on the payment request;
validating the payment request message;
submitting the payment request message to a receiver financial institution;
receiving, from the receiver financial institution, a tokenized URL created out of a requested parameter comprising the payment request message; and
generating a link for the application associated with the first account, the link comprising an approval for the payment request; and
a receiver financial institution computing system comprising one or more receiver financial institution processors and one or more receiver financial institution memories storing receiver financial institution instructions that, when executed by the one or more receiver financial institution processors, cause the receiver financial institution computing system to perform operations comprising:
creating the tokenized URL out of the requested parameter comprising the payment request message;
receiving a response to the link comprising one or more customer credentials;
decoding the tokenized URL;
receiving a request for payment form and one or more customer details;
comparing the request for payment form and the one or more customer details against a customer information database; and
blocking a transaction associated with the payment request when the comparison of the request for payment form and the one or more customer details is not verified.

20. A non-transitory computer-readable medium storing instructions that, when executed by one or more processors, cause operations comprising:
receiving, by an application executed by the one or more processors, a payment request by an application associated with a first account;
creating, by the application, a payment request message based on the payment request;
validating, by a merchant, the payment request message;
submitting, by the merchant, the payment request message to a receiver financial institution;
creating, by the receiver financial institution, a tokenized URL out of a requested parameter comprising the payment request message;
receiving, at the merchant, the tokenized URL;
generating, by the merchant, a link for the application associated with the first account, the link comprising an approval for the payment request;
receiving, by the receiver financial institution, a response to the link comprising one or more customer credentials;
decoding, by the receiver financial institution, the tokenized URL;
receiving, by the receiver financial institution, a request for payment form and one or more customer details;
comparing, by the receiver financial institution, the request for payment form and the one or more customer details against a customer information database; and
blocking a transaction associated with the payment request if the comparison of the request for payment form and the one or more customer details is not verified.
